(19) United States
(12) Patent Application Publication
(10) Pub. No.: US 2004/0182207 A1
(43) Pub. Date: Sep. 23, 2004

(54) Detachment device of the engine oil filter of an automobile

(76) Inventor: Pi-Liang Wu, Taichung (TW)

Correspondence Address: Pi-Liang Wu, P. O. Box 55-124, Taichung, TW

(21) Appl. No.: 10/392,172

(22) Filed: Mar. 20, 2003

(51) Int. Cl. B25B 13/18

(52) U.S. Cl. 81/128

(57) ABSTRACT

A detachment device of the engine oil filter of an automobile includes a base, two toggle plates, two clamping plates, and two link mechanisms. The clamping plates are connected by the link mechanisms which cannot be returned automatically, so that the user needs not to exert a large force to pull and push the two clamping plates, thereby facilitating the user's operation. In addition, each connecting portion has a width different from the diameter of the base, thereby forming a gap between the base and each connecting portion, so that the user can clearly watch the present position of the engine oil filter, thereby facilitating the user mounting and detaching the engine oil filter.

### BACKGROUND OF THE INVENTION

1. Field of the Invention

The present invention relates to a detachment device of the engine oil filter of an automobile, and more particularly to a detachment device of the engine oil filter of an automobile, wherein the detachment device can be operated easily and conveniently.

2. Description of the Related Art

The engine oil filter is mounted in the automobile for filtering the impurities, such as the ferrite chips, the carbon particles or the like, contained in the engine oil. The engine oil filter is mounted in the engine chamber of the automobile. Thus, it is necessary to provide a detachment device for locking and mounting the engine oil filter in the engine chamber of the automobile or detaching the engine oil filter from the engine chamber of the automobile.

### SUMMARY OF THE INVENTION

The primary objective of the present invention is to provide a detachment device of the engine oil filter of an automobile, wherein the two clamping plates are connected by each of the two link mechanisms which cannot be returned automatically, so that the user needs not to exert a large force to pull and push the two clamping plates to move, thereby saving the manual work, and thereby facilitating the user's operation.

Another objective of the present invention is to provide a detachment device of the engine oil filter of an automobile, wherein each of the two link mechanisms cannot be returned automatically, so that when the two clamping plates are pushed inward relative to each other, the two clamping plates will not clip the user's fingers, thereby protect the user's safety.

A further objective of the present invention is to provide a detachment device of the engine oil filter of an automobile, wherein each of the two connecting portions has a width different from the diameter of the base, thereby forming a gap between the base and each of the two connecting portions, so that the user can clearly watch the present position of the engine oil filter, thereby facilitating the user mounting and detaching the engine oil filter.

In accordance with the present invention, there is provided a detachment device of the engine oil filter of an automobile, comprising:

a base having a periphery formed with two radially opposite connecting portions each having a width smaller than that of the base;

two toggle plates each having a first end pivotally mounted on a respective one of the two connecting portions of the base;

two clamping plates each pivotally mounted on a second end of a respective one of the two toggle plates; and

two link mechanisms each mounted between the two clamping plates, and each having a length that is changed with a relative distance between the two clamping plates.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a detachment device of the engine oil filter of an automobile in accordance with the preferred embodiment of the present invention;

FIG. 2 is a perspective assembly view of the detachment device of the engine oil filter of an automobile in accordance with the preferred embodiment of the present invention;

FIG. 3 is a top plan view of the detachment device of the engine oil filter of an automobile as shown in FIG. 2;

FIG. 4 is a front plan view of the detachment device of the engine oil filter of an automobile as shown in FIG. 2;

FIG. 5 is a schematic operational view of the detachment device of the engine oil filter of an automobile as shown in FIG. 3 in use;

FIG. 6 is a schematic operational view of the detachment device of the engine oil filter of an automobile as shown in FIG. 4 in use;

FIG. 7 is a schematic operational view of the detachment device of the engine oil filter of an automobile as shown in FIG. 3 in use;

FIG. 8 is a schematic operational view of the detachment device of the engine oil filter of an automobile as shown in FIG. 3 in use; and

FIG. 9 is a schematic operational view of the detachment device of the engine oil filter of an automobile as shown in FIG. 8.

### DETAILED DESCRIPTION OF THE INVENTION

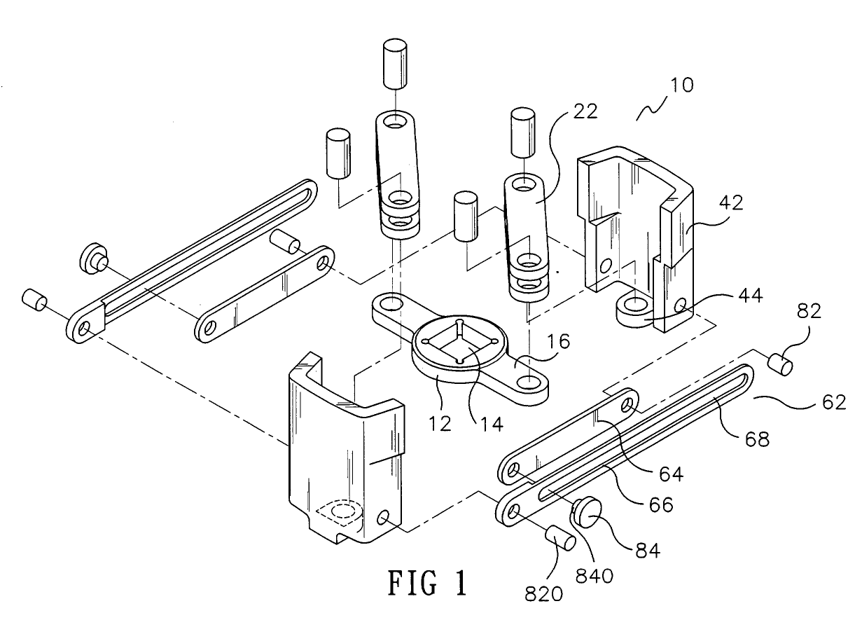

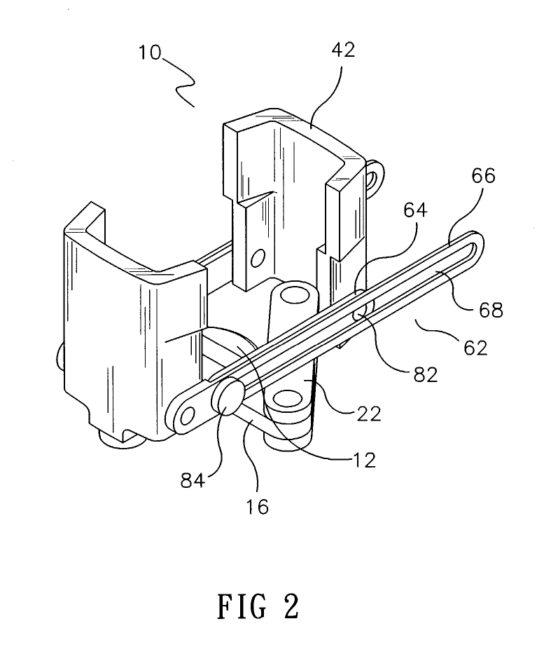

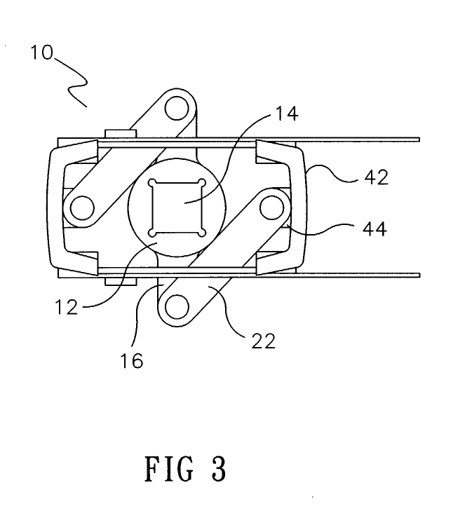

Referring to the drawings and initially to FIGS. 1-3, a detachment device 10 of the engine oil filter of an automobile in accordance with the preferred embodiment of the present invention comprises a base 12, two toggle plates 22, two clamping plates 42, and two link mechanisms 62.

The base 12 has a circular shape and has a center formed with a square hole 14. The base 12 has a periphery formed with two radially opposite connecting portions 16. Each of the two connecting portions 16 has a width smaller than the diameter of the base 12.

Each of the two toggle plates 22 has a first end pivotally mounted on a respective one of the two connecting portions 16 of the base 12.

Each of the two clamping plates 42 has a substantially U-shaped cross-section. Each of the two clamping plates 42 has a bottom pivotally mounted on a second end of a respective one of the two toggle plates 22. The bottom of each of the two clamping plates 42 is formed with a pivot portion 44 pivotally mounted on the second end of the respective toggle plate 22.

Each of the two link mechanisms 62 is mounted between the two clamping plates 42, and includes a first link 64 and a second link 66.

The first link 64 of each of the two link mechanisms 62 has a first end secured on a respective side of one of the two clamping plates 42 by a positioning member 82.

The second link 66 of each of the two link mechanisms 62 has a first end and a second end, and the first end is secured on a respective side of the other one of the two clamping plates 42 by a positioning member 820. The second link 66 of each of the two link mechanisms 62 is formed with an elongate guide slot 68 extended from the first end to the second end thereof. The positioning member 82 is slidably mounted in the guide slot 68. The first link 64 and the second link 66 are displaced relative to each other in a translation manner.

Each of the two link mechanisms 62 further includes a locking knob 84 rested on the second link 66. The locking knob 84 has a reduced neck portion 820 extended through the guide slot 68 and secured on a second end of the first link 64.

In such a manner, the two clamping plates 42 can be moved relative to each other so as to lengthen or shorten the distance between the two clamping plates 42.

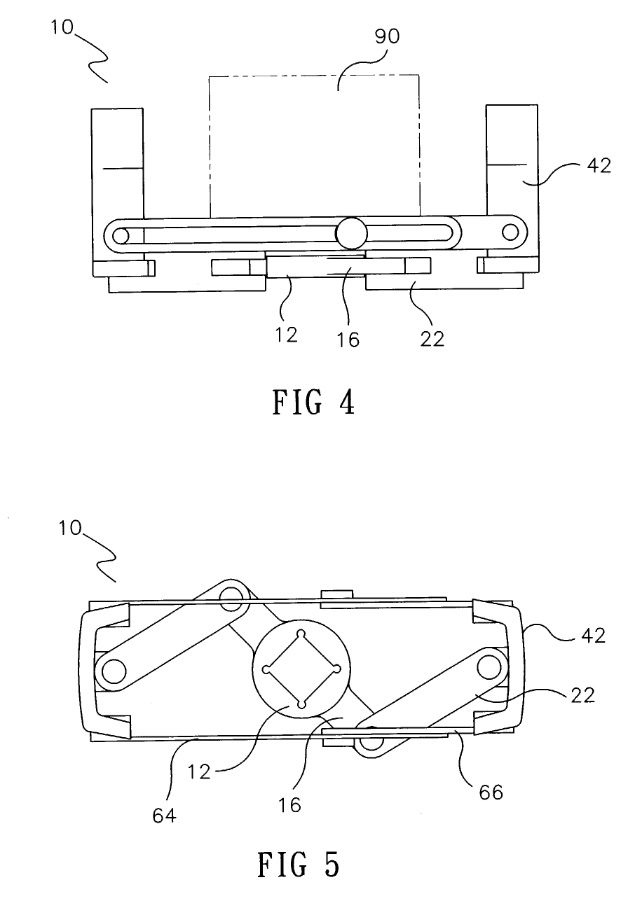

Referring to FIGS. 4 and 5, the two clamping plates 42 are pulled outward relative to each other so as to lengthen the distance between the two clamping plates 42. At this time, the two toggle plates 22 are pulled outward to pivot the two connecting portions 16 of the base 12, so that the base 12 is rotated. Meanwhile, the first link 64 and the second link 66 of each of the two link mechanisms 62 are moved relative to each other. Thus, the engine oil filter 90 can be placed on the base 12 and located between the two clamping plates 42.

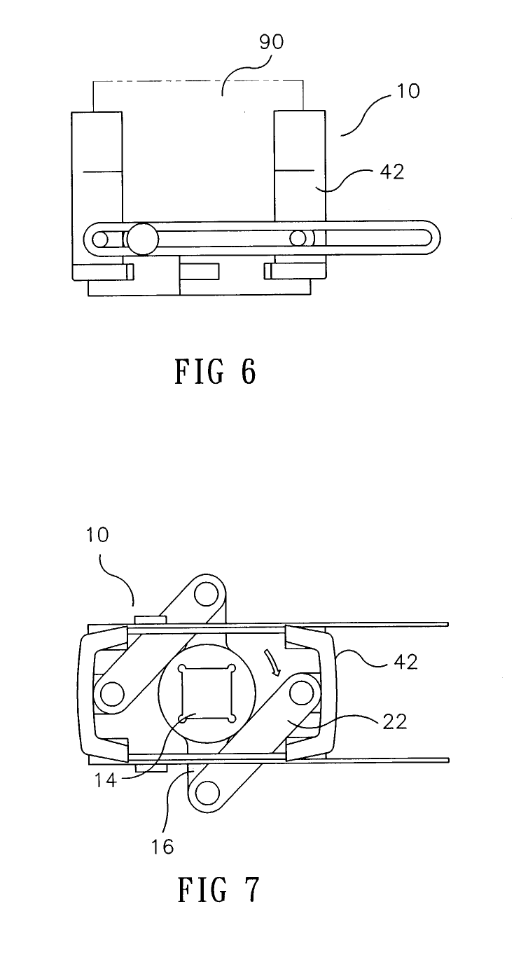

Referring to FIGS. 6 and 7, the two clamping plates 42 are pushed inward relative to each other so as to shorten the distance between the two clamping plates 42, so that the engine oil filter 90 is sandwiched between the two clamping plates 42 as shown in FIG. 7. Then, the user can use a socket wrench (not shown) to rotate the base 12, with the drive stud (not shown) of the socket wrench being inserted into the square hole 14 of the base 12. In such a manner, the base 14 can be rotated clockwise as shown in FIG. 7, to rotate the two connecting portions 16 which the two toggle plates 22 which pull the two clamping plates 42, so that the engine oil filter 90 can be closely clamped between the two clamping plates 42. Thus, when the base 14 is rotated clockwise as shown in FIG. 7, the engine oil filter 90 is clamped between the two clamping plates 42 and can be closely tightened and locked in the engine chamber (not shown) of the automobile.

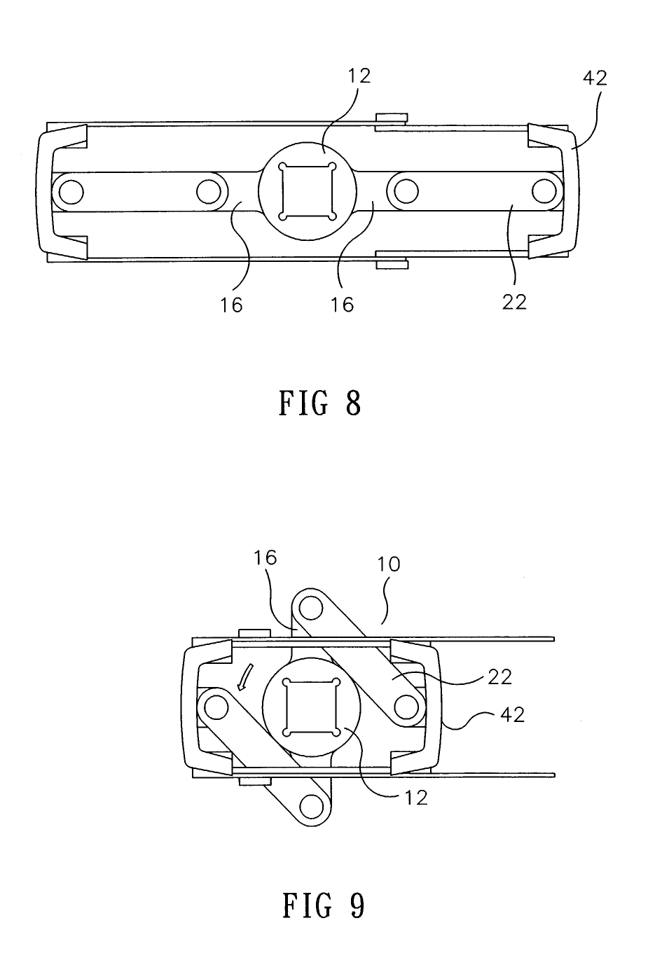

Referring to FIGS. 8 and 9, the two clamping plates 42 are pulled outward relative to each other so as to lengthen the distance between the two clamping plates 42 to the maximum. Then, the two clamping plates 42 are pushed inward relative to each other so as to shorten the distance between the two clamping plates 42, so that the engine oil filter 90 is sandwiched between the two clamping plates 42 as shown in FIG. 9. In such a manner, the base 14 can be rotated counterclockwise by the drive stud of the socket wrench as shown in FIG. 9, to rotate the two connecting portions 16 which the two toggle plates 22 which pull the two clamping plates 42, so that the engine oil filter 90 can be closely clamped between the two clamping plates 42. Thus, when the base 14 is rotated counterclockwise as shown in FIG. 9, the engine oil filter 90 is clamped between the two clamping plates 42 and can be unscrewed from in the engine chamber of the automobile for replacement.

Accordingly, the two clamping plates 42 are connected by each of the two link mechanisms 62 which cannot be returned automatically, so that the user needs not to exert a large force to pull and push the two clamping plates 42 to move, thereby saving the manual work, and thereby facilitating the user's operation. In addition, each of the two link mechanisms 62 cannot be returned automatically, so that when the two clamping plates 42 are pushed inward relative to each other, the two clamping plates 42 will not clip the user's fingers, thereby protect the user's safety. Further, each of the two connecting portions 16 has a width different from the diameter of the base 12, thereby forming a gap between the base 12 and each of the two connecting portions 16, so that the user can clearly watch the present position of the engine oil filter 90, thereby facilitating the user mounting and detaching the engine oil filter 90.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A detachment device of the engine oil filter of an automobile, comprising:
a base having a periphery formed with two radially opposite connecting portions each having a width smaller than that of the base;
two toggle plates each having a first end pivotally mounted on a respective one of the two connecting portions of the base;
two clamping plates each pivotally mounted on a second end of a respective one of the two toggle plates; and
two link mechanisms each mounted between the two clamping plates, and each having a length that is changed with a relative distance between the two clamping plates.

2. The detachment device of the engine oil filter of an automobile in accordance with claim 1, wherein the base has a circular shape.

3. The detachment device of the engine oil filter of an automobile in accordance with claim 1, wherein the base has a center formed with a square hole.

4. The detachment device of the engine oil filter of an automobile in accordance with claim 1, wherein each of the two clamping plates has a substantially U-shaped cross-section.

5. The detachment device of the engine oil filter of an automobile in accordance with claim 1, wherein each of the two clamping plates has a bottom formed with a pivot portion pivotally mounted on the second end of the respective toggle plate.

6. The detachment device of the engine oil filter of an automobile in accordance with claim 1, wherein each of the two link mechanisms includes a first link and a second link, the first link has a first end secured on a respective side of one of the two clamping plates, the second link has a first end and a second end, the first end of the second link is secured on a respective side of the other one of the two clamping plates.

7. The detachment device of the engine oil filter of an automobile in accordance with claim 6, wherein the first end of the first link is secured on a respective side of one of the two clamping plates by a positioning member.

8. The detachment device of the engine oil filter of an automobile in accordance with claim 6, wherein the first end of the second link is secured on a respective side of the other one of the two clamping plates by a positioning member.

9. The detachment device of the engine oil filter of an automobile in accordance with claim 6, wherein the first link and the second link are displaced relative to each other in a translation manner.

10. The detachment device of the engine oil filter of an automobile in accordance with claim 6, wherein the second link of each of the two link mechanisms is formed with an elongate guide slot extended from the first end to the second end thereof.

11. The detachment device of the engine oil filter of an automobile in accordance with claim 10, wherein the first end of the first link is secured on a respective side of one of the two clamping plates by a positioning member which is slidably mounted in the guide slot.

12. The detachment device of the engine oil filter of an automobile in accordance with claim 10, wherein each of the two link mechanisms further includes a locking knob rested on the second link, the locking knob has a reduced neck portion extended through the guide slot and secured on a second end of the first link.
